(19) United States
(12) Patent Application Publication
(10) Pub. No.: US 2007/0183515 A1
(43) Pub. Date: Aug. 9, 2007

(54) Method and apparataus for transmitting data in a multi-antenna wireless system

(75) Inventors: Wei Lih Lim, Singapore (SG); Pek Yew Tan, Singapore (SG); Chalermphol Apichaichalermwongse, Osaka (JP); Kazuhiro Ando, Osaka (JP); Yasuo Harada, Hyogo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 10/597,883

(22) PCT Filed: Feb. 25, 2005
(86) PCT No.: PCT/JP05/03667

§ 371 Date: Oct. 16, 2006

(30) Foreign Application Priority Data
Feb. 27, 2004 (JP) 2004/053860

(51) Int. Cl. H04K 1/10

(52) U.S. Cl. 375/260

(57) ABSTRACT

The invention is to improve the throughput for a wireless transmission. Multiple antennas are activated in the same frequency at the same time to facilitate parallel transmission. A systematic processes are provided to achieve high throughput transmission.

### TECHNICAL FIELD

The present invention relates to the method and apparatus to facilitate categorization of medium resources for multi-antenna wireless system to achieve high throughput wireless transmission.

### BACKGROUND ART

In prior art, means to achieve high throughput are being introduced. Although these means can be employed in multiple antenna system, but means to categorize each instant of medium resource to perform schedule and coordination in order to achieve high throughput in a more efficient manner are not being described. Furthermore, a systematic manner to enhance from the existing system is not being illustrated.

### DISCLOSURE OF INVENTION

### Problems to be Solved by the Invention

In multiple antennas system, multiple antennas can be activated in the same frequency at the same time to facilitate parallel transmission, with the limitation that the number of transmitting antennas cannot be greater than the number of receiving antennas. In order for a receiver to receive and decode those parallel transmissions, the channel response of each corresponding transmitting antenna must be known by receiver. So, before information bits are being transmitted, the pilot symbols are required to be transmitted in order to obtain awareness and provide information for receiver to estimate the channel response. Furthermore, more reliable channel coding and methods to increase throughput efficiency are required in order to compensate the effect introduced by higher order modulation.

### MEANS FOR SOLVING THE PROBLEMS

The invention solves the problems by providing a systematic processes to enhance from the existing system in order to achieve high throughput transmission; a means to classify medium resources and identify each instant of medium resources using a unique ID in order to facilitate medium resources scheduling and channel estimation; a means to perform medium resources scheduling in order to abstract and produce information that are to be used for performing medium resources dedication; a means to provide necessary information to receiving entity in order to facilitate decoding of streams that are transmitted by multiple transmitting entities in parallel using multiple antennas; an apparatus that is capable of dynamically change transformation mode on bits stream in order to produce transmission signal base on each transmission setup; a means to transmit each sub streams that are divided from a bits stream in parallel using multiple antennas or multiple sets of frequency sub-carrier as well as a means to transmit a bits stream in a more reliable manner using multiple antennas or multiple sets of frequency sub-carrier.

With the present invention, QoS requirements of wireless transmitting entities are being acquired by a medium resources coordinator, which are then used as inputs to a medium resources scheduler to generate medium dedication schedule. At each fix dedication interval, medium dedication frames are being generated and transmitted to each wireless transmitting entity. It dedicates wireless transmitting entities with medium resources for a specific duration. The wireless transmitting entity that owns a special medium resource is required to perform transmission setup. After the setup, each transmitting antenna is required to transmit a sequence of pilot symbols in sequence in order to facilitate all receiving entities to be able to estimate the channel response of each corresponding transmitting antenna. This is required in order to be able to decode transmission signal successfully. Then, each transmitting entity can start transmission in parallel. A bits stream that is to be transmitted is being processed by an apparatus, which convert bits stream into transmission signals that are more resistant to channel errors.

### BRIEF DESCRIPTION OF DRAWINGS

FIG. 1 shows a flow diagram to illustrate the processes that are required to achieve high throughput wireless transmission.

FIG. 2 shows a block diagram of an OFDM transmitter.

FIG. 3 shows a block diagram of an OFDM receiver.

FIG. 4 shows an overview of all building blocks for a transformer.

FIG. 5 is a bit stream diagram showing the relationship sub streams, segments and fragments.

FIG. 6 is a diagram showing the bit stream divided into sub streams, segments and fragments.

FIG. 7 is a flowchart showing steps to generate fragments.

FIG. 8 is a flowchart showing steps to process the fragments.

FIG. 9 is a block diagram of a coding device according to the first embodiment.

FIG. 10 is a block diagram of a coding device according to the second embodiment.

FIG. 11 is a block diagram of a coding device according to the third embodiment.

FIG. 12 is a block diagram of a coding device of a according to the fourth embodiment.

FIG. 13 is a diagram showing a wireless LAN system employing a multiple antenna transmission arrangement according to the present invention.

FIG. 14 is a diagram showing a poll frame structure.

FIG. 15 is a diagram showing the structure of a data transmitted in the multiple antenna transmission arrangement.

FIG. 16 is a diagram showing the first pattern of the data transmitted from three antennas provided in one station.

FIG. 17 is a diagram showing the second pattern of the data transmitted from three antennas provided in one station.

FIG. 18 is a diagram showing the third pattern of the data transmitted from three antennas provided in one station.

FIG. 19 is a diagram showing the fourth pattern of the data transmitted from three antennas provided in one station.

FIG. 20 is a diagram showing a time chart for sending data.

FIG. 21 is a diagram showing a time chart for sending data.

### BEST MODE FOR CARRYING OUT THE INVENTION

In the following description, for purpose of explanation, specific numbers, times, structures, and other parameters are set forth in order to provide a thorough understanding of the present invention. The following paragraphs give an exemplification of how the invention can be implemented. However, it will be apparent to anyone skilled in the art that the present invention may be practiced without these specific details.

To help understand the invention easier, the following definitions are used:

The term “Data Train” refers to a MAC protocol data unit that consists of multiple data units that are being kept in compartments individually.

The term “Transmission unit” refers to a series of transmission that is initiated by only one transmitting entity. In a Transmission Unit, it can consist of one or more physical layer protocol data units.

The term “WM” refers to the Wireless Medium.

The term “QoS” refers to Quality of Service.

The term “MAC” refers to Media Access Controller

In the recent communication market, the use of Wireless Local Area Network (WLAN) technology is growing rapidly. With more and more applications delivered using wireless technology, it has become more and more necessary to increase the data rate of wireless transmission. This can be achieved by increasing the bandwidth of a wireless channel, employing higher order modulation techniques, utilizing advance channel coding and facilitating parallel transmissions. These techniques permit more data bits to be transmitted during an instant of time duration which required changes to the physical layer implementation or transceiver of existing wireless equipment. Besides these changes, the format and method that a transmission unit is formulated required to be revolutionized otherwise it will reduce the throughput efficiency significantly.

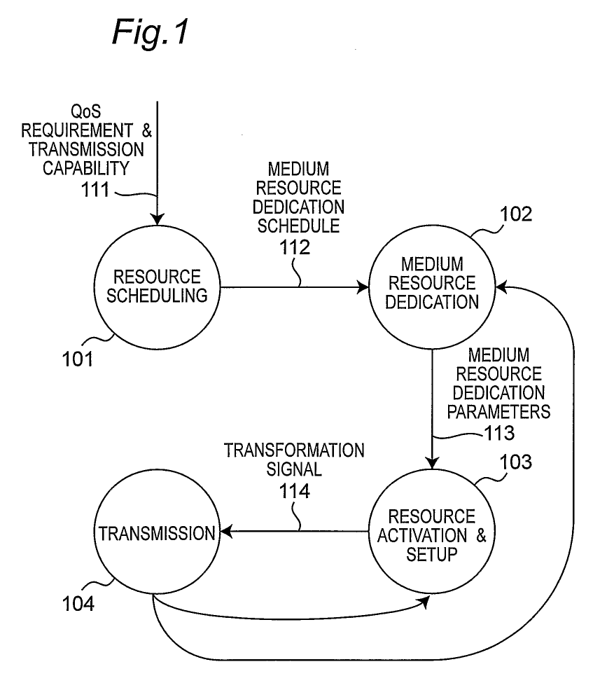

FIG. 1 is a flow diagram that represents the mandatory processes that are required to achieve significant and sensible throughput increment that is measuring at MAC SAP. Those processes are resource scheduling 101, medium resource dedication 102, resource activation & setup 103 and transmission 104. The operation started by a medium resource coordinator to gather and collect QoS requirement and transmission capabilities of each transmission entity. The detail description of this process can be found in a Japanese Patent application 2003-313997 filed on Sep. 5, 2003 by the same applicant as the present application. Japanese Patent application 2003-313997 is herein enclosed by reference. Using that information as input, a Medium Resource Dedication Schedule for each transmitting entity is being generated. Then, medium resources are being dedicated to each transmitting entity base on corresponding schedule to facilitate transmission in order to fulfill their respective QoS requirement. Transmitting entity that is being dedicated with specific resources is required to initiate the transmission and transmit necessary information in order to understand the transmission. Each transmitting entity that are being dedicated with resources for transmission have to train all wireless receivers such that they are capable to receive and decode bit streams that are being transmitted using the medium resources that are being dedicated. After resource setup and activation, data payload that may contains aggregated data units are being processed and transmitted.

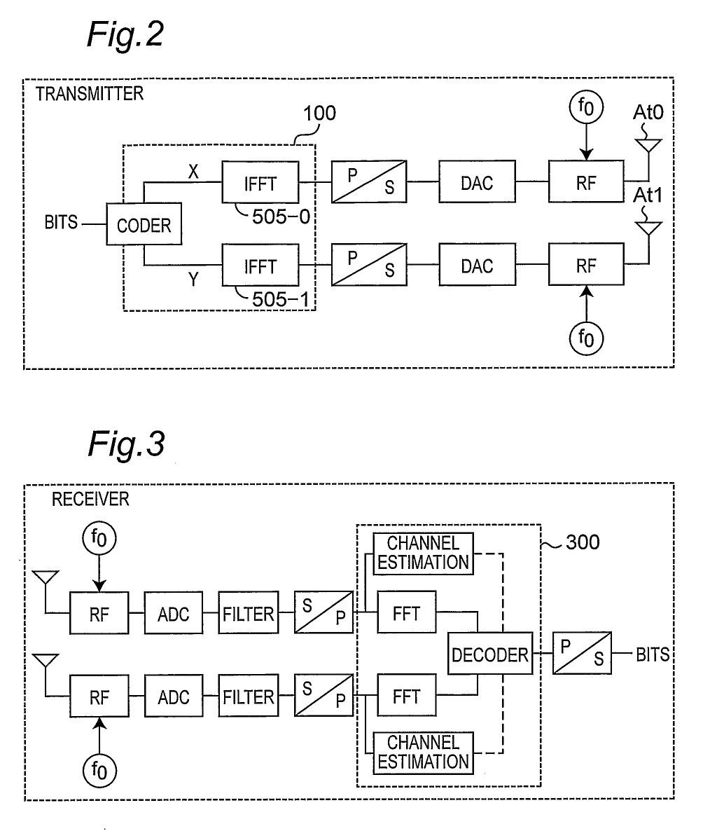

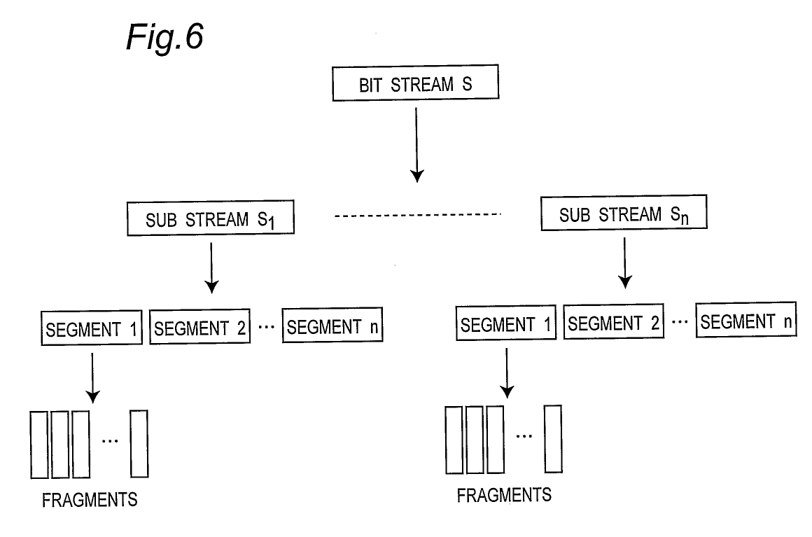

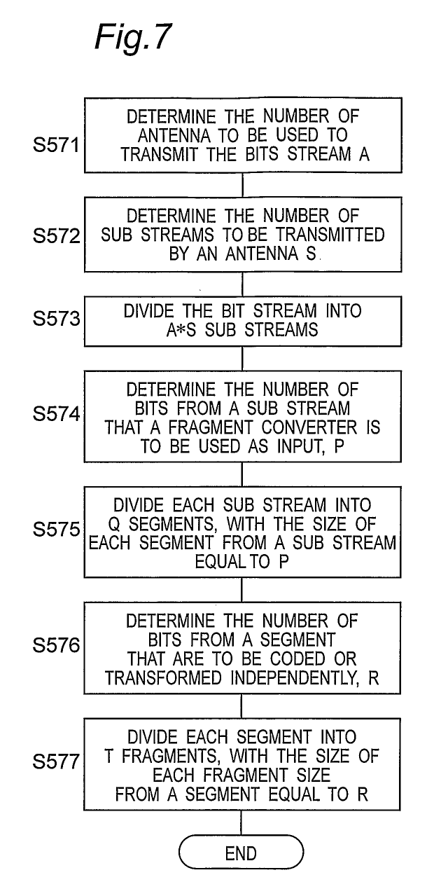

The current highest transmission rate that can be achieved by existing WLAN equipment is very limited in range space. With the use of multiple antennas system, concept of spatial multiplexing and diversity are being introduced. Throughput of the system can be increased without increasing the frequency bandwidth and longer transmission distance can be achieved with an acceptable BER. FIGS. 2 and 3 show a simplified OFDM transceiver that is associated with each antenna for a MIMO configuration. FIG. 2 shows the transmitter and FIG. 3 shows the receiver. The box 100 in the FIG. 2 is a coding device which performs core operations in order to achieve higher throughput and more reliable transmission. In the coding device 100, the bit stream is divided into fragments, and each fragment is coded according to the space frequency block coding, space time block coding or spatial multiplexing coding, or any other coding. The steps for dividing the bit stream into fragments is shown in FIGS. 6 and 7.

Referring to FIG. 6, at step 1, the bit stream S is divided into sub streams. At step 2, each sub stream is divided to construct multiple segments. At step 3, at each fix interval, the first unprocessed segment of all sub streams is fragmented into multiple fragments.

Referring to FIG. 7, at step 571, a number, A, of antenna to be used to transmit the bit stream is determined. At step 572, a number, S, of sub streams to be transmitted by an antenna is determined. At step 573, the bit stream is divided into sub streams. The number of sub streams will be equal to A*S. At step 574, a number, P, of bits from a sub stream is determined for use in a segment. At step 575, each sub stream is divided into Q segments. At step 576, a number, R, of bits from a segment is determined for use in a fragment. At step 577, each segment is divided into n fragments, n being a positive integer. As one example, it is assumed that each fragment includes 8 bits, each segment includes 48 fragments, and each sub stream includes 120 segments. Also, it is assumed that two antennas are provided. In this case, antenna number A=2, segment length P=384 bit, fragment length R=8 bit, fragments per segment n=48, segments per sub stream Q=120.

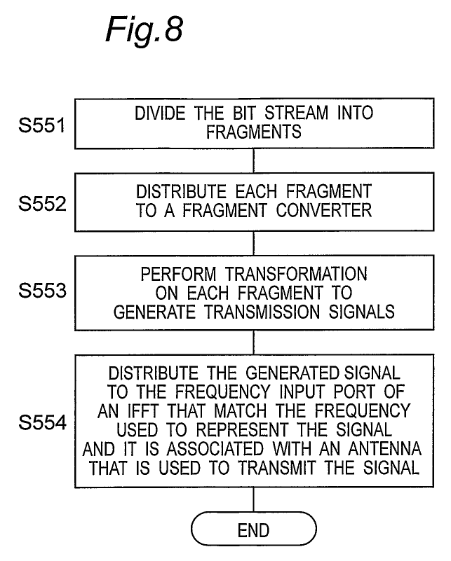

An overview of the operations to be performed is shown in FIG. 8. At step 551, bit stream is divided into fragments. At step 552, each fragment is distributed to a fragment converter. At step 553, each fragment is transformed to a transmission signal. At step 554, the transmission signal is distributed to a frequency input port of an IFFT that match the frequency used to represent the signal and. Each IFFT is associated with an antenna that is used to transmit the signal.

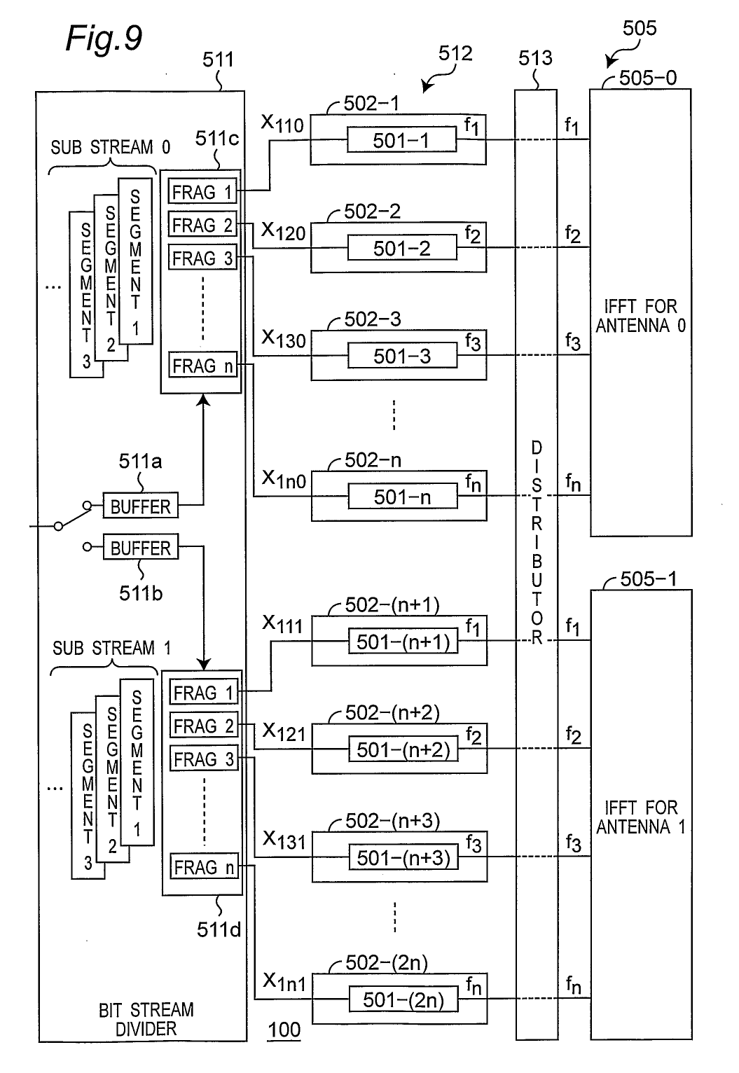

FIG. 9 shows a detail of coding device 100, according to the first embodiment, for performing the spatial multiplexing coding. A coding device 100 includes a bits stream divider 511, a converter array 512, a frequency and antenna distributor 513 and an IFFT array 505. The input for the bits stream divider 511 is a variable or fix size bit stream that is to be transmitted. The bit stream divider 511 includes buffers 511a and 511b, each having a sufficient capacity to store one sub stream, and shift register arrays 511c and 511d. Each of shift register arrays 511c and 511d includes n shift registers, and each shift register is capable of holding one fragment data, i.e., R bits. According to the above example, each shift register array includes 48 shift registers, and each shift register is capable of holding 8 bits.

The bit stream divider 511 divides the input bit stream into multiple sub streams, each sub stream into multiple segments, and each segment into multiple fragments as described below.

The input bit stream is stored in buffer 511a for an amount equal to one sub stream, and the following bit stream is stored in buffer 511b for an amount equal to one sub stream. In this manner, buffers 511a and 511b alternately store bit stream of one sub stream length. Buffer 511a stores sub stream 0 and buffer 511b stores sub stream 1 in the first cycle operation, and buffer 511a stores sub stream 2 and buffer 511b stores sub stream 3 in the second cycle operation. From buffer 511a, the first 8 bits are stored in the first shift register as fragment 1, the second 8 bits are stored in the second shift register as fragment 2, and so on. Similarly, from buffer 511b, the first 8 bits are stored in the first shift register as fragment 1, the second 8 bits are stored in the second shift register as fragment 2, and so on. When all the shift registers in shift register arrays 511c and 511d are filled with 8 bit data, the data are simultaneously transferred to the respective converters 502-1 to 502-2n in the converter array 512. In this manner, the fragments 1 to n in segment 1 of sub stream 0 and the fragments 1 to n in segment 1 of sub stream 1 are simultaneously transferred to respective converters 502-1 to 502-2n.

When all the fragments 1-n in the first segment 1 are sent from shift register arrays 511c and 511d to the converter array 512, the shift registers in the shift register arrays 511c and 511d are ready to receive the next fragment data in segment 2. In this manner, from each buffer, the data are processed by the unit of segment, and when all the segments in one sub stream are processed, the buffer is filled with the next sub stream. When two buffers are provided, as in the coding device 100 shown in FIG. 9, the bit stream can be processed and transmitted twice the speed.

Converter array 512 includes 2n converters 502-1 to 502-2n. Converters 502-1 to 502-n are for the fragments 1 to n from the first shift register array 511c, and converters 502-(n+1) to 502-2n are for fragments 1 to n from the second shift register array 511d. In FIG. 9, fragments 1 to n from shift register array 511c are also indicated as fragments X₁₁₀ to X₁ₙ₀. In other words, a fragment is generally indicated by Xᵢⱼₖ, in which i represents the segment number starting from 1, j represents the fragment number starting from 1, and k represents the sub stream number starting from 0.

Each converter includes one or more transformers. In the embodiment shown in FIG. 9, each converter includes one transformer. For example, converter 502-1 includes a transformer 501-1.

The number of transformer in each fragment converter depends on the type of transformation performed on each fragment in order to generate transmission signals. For an example, the type of transformation can either be spatial multiplexing coding, space time block coding, space frequency block coding or any other coding that enhances the error resistance of the signal generated. It can also be a combination of multiple transformations to generate the final transmission signal. Each transformer in a fragment converter is associated with a frequency and an antenna. The output of a transformer is a transmission signal that is frequency coded, which is then distributed to a pipeline that is associated with an antenna by Frequency & Antenna Distributor.

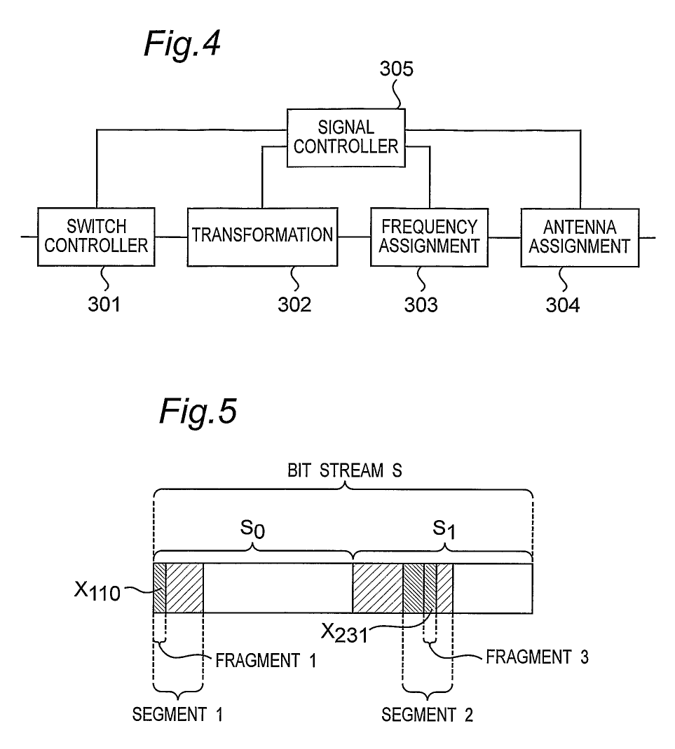

A detail of the transformer 501-1 is shown in FIG. 4.

Referring to FIG. 4, transformer 501-1 includes a switch controller 301, a transformation unit 302, a frequency assignment unit 303, an antenna assignment unit 304 and a signal controller 305.

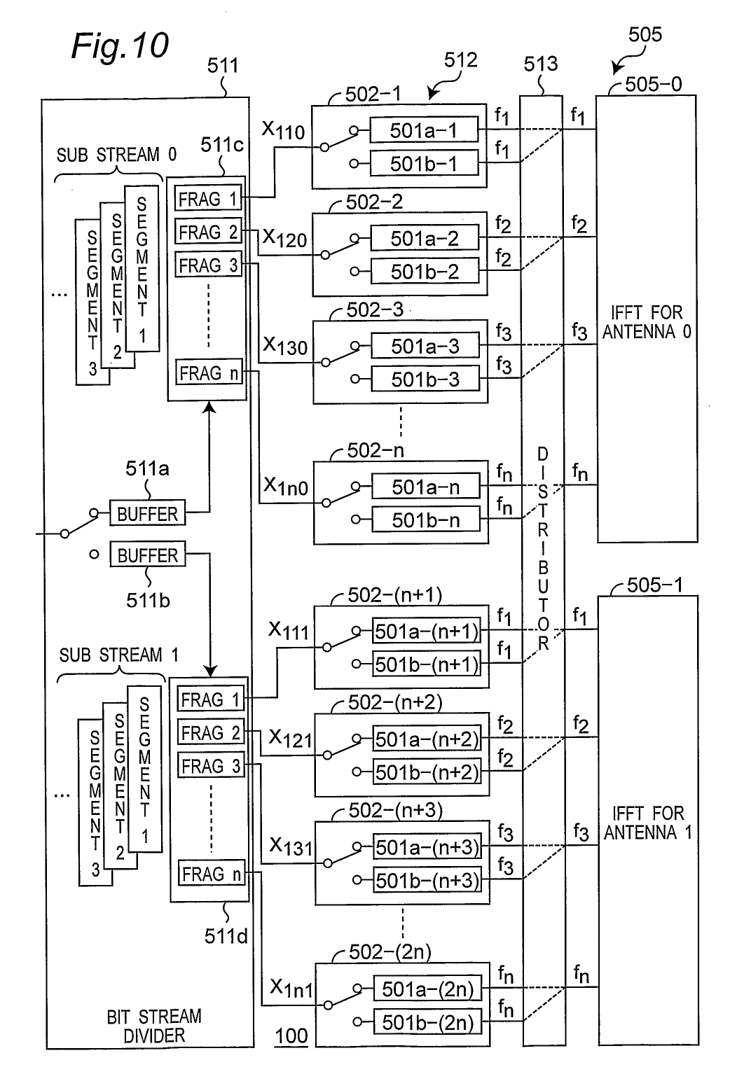

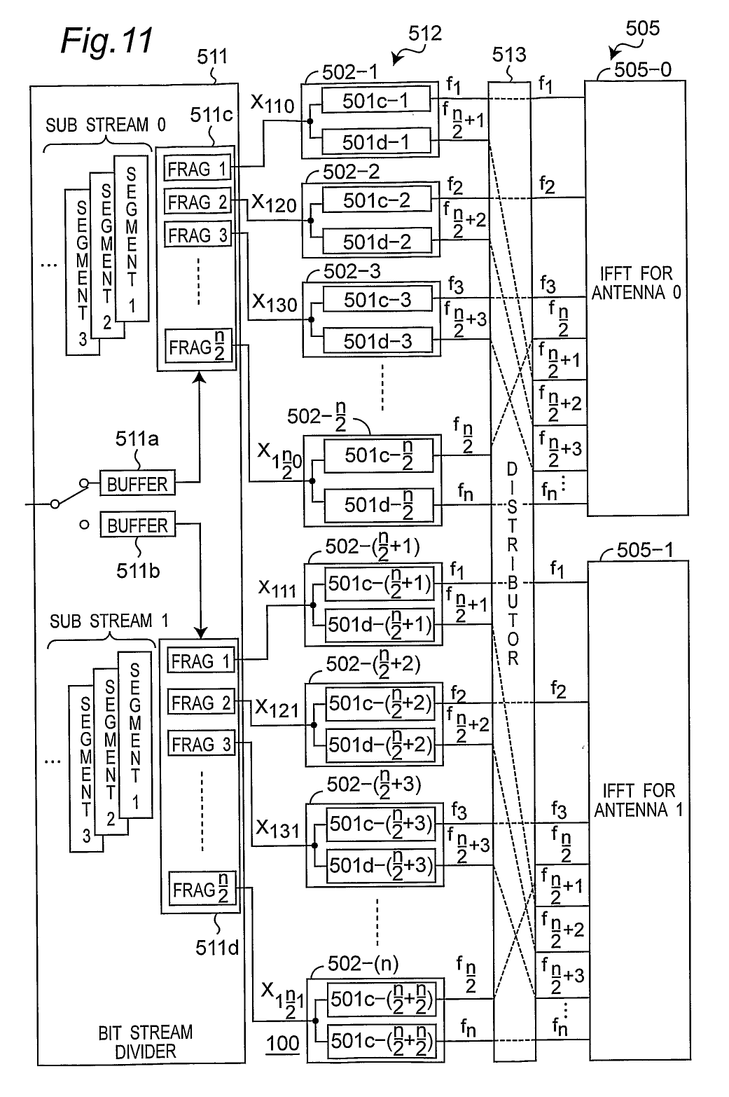

The switch controller 301 is used to control a switch provided at the input side of each transformer 501-1. For example, in the case of coding device 100 shown in FIG. 9, the switch provided at the input side of each transformer is always closed, so that such switch is omitted for the sake of brevity. However, in the case of coding device 100 shown in FIG. 10, the switch provided at the input side of each transformer is alternately turned on and turned off. More specifically, in FIG. 10, the switch provided at the input side of transformer 501a-1 is turned on during the transmission of a first half of the fragment, and is turned off during the transmission of a second half of the fragment. The switch provided at the input side of transformer 501b-1 performs opposite, i.e., it is turned off during the transmission of a first half of the fragment, and is turned on during the transmission of a second half of the fragment. In FIG. 10, the switch is shown in a simplified manner. In the case of coding device 100 shown in FIG. 11, the switch provided at the input side of each transformer is always closed, so that such switch is omitted for the sake of brevity.

The Transformation unit 302 performs a transformation on the input signal in order to produce an output signal that is more resistant to error. The frequency assignment unit 303 assigns a frequency for coding the signal being processed by the transformer. The antenna assignment unit 304 assigns an antenna for transmitting the output signal. The signal controller 305 provides coordination signals for the four units 301 to 304. Output of a transformer is connected to a distributor 513 which is for distributing the output signal of each transformer according to the assigned frequency and antenna. The function of distributor 513 is to distribute the input signal to one of input ports of an IFFT 505 according to the assigned frequency representation and antenna index. Each IFFT 505 is associated with an antenna, which contains fn number of input ports. The number fn is equal to the number of frequency sub-carriers that are available for transmission. Each input port is assigned by distributor 513 a frequency coded signal combined with other signals from other input ports to generate a time domain transmission signal. As shown in FIG. 2, IFFT 505-0 is associated with antenna At0 and IFFT 505-1 is associated with antenna At1.

As shown in FIG. 3, the receiver has a decoding device 300. The decoding device 300 is arranged to do the opposite operation of the coding device 100. The decoding device 300 includes FFTs and a decoder. Furthermore a channel estimation unit is provided to each path from the antenna for estimating or acknowledging a channel. The channel estimation unit acknowledges the channel during a training sequence.

Referring to FIG. 10, a coding device 100, according to the second embodiment, for performing the space time block coding is shown. The coding device 100 of FIG. 10 differs from that shown in FIG. 9 in the converter array 512 and in the distributor 513. Other parts of the coding device 100 of FIG. 10 are the same as that shown in FIG. 9, so the description thereof is omitted. The converter array 512 of FIG. 10 includes n converters 502-1 to 502-n which are connected to shift registers in shift register array 511c, and n converters 502-(n+1) to 502-2n which are connected to shift registers in shift register array 511d. Each converter, such as converter 502-1 includes two transformers 501a-1 and 501b-1, and a switching element controlled by switch controller 301 (FIG. 4). The transformer 501a-1 transforms a portion of the fragment, and the transformer 501b-1 transforms a remaining portion of the fragment. The switching element switches between the first half of the fragment and the second half of the fragment. For example, when the fragment is 8 bit long, the former 4 bit data is applied to the transformer 501a-1 and the later 4 bit data is applied to the transformer 501b-1. In this case, each transformer employs 4-bit coding. The switching element shown in FIG. 10 is a flip type switch, but can be replaced with an on/off switch provided at the input side of each transformer.

The signals from the two transformers 501a-1 and 501b-1 are applied to distributor 513 which applies these two signals to input port of frequency f1 of IFFT 505-0.

According to the embodiment shown in FIG. 10, the two transformers 501a-1 and 501b-1 in the converter 502-1 are processed in the same frequency f1, but in a modification, it is possible to use different frequencies. In such a case, the distributor 513 sends the signals from the transformers to different frequency input ports. Also, the signals from the two transformers 501a-1 and 501b-1 in the converter 502-1 are applied to the same IFFT, but in a modification, it is possible to apply the signals to different IFFTs. For example, the signal from transformer 501a-1 is applied to IFFT 505-0, and the signal from transformer 501b-1 is applied to IFFT 505-1.

Referring to FIG. 11, a coding device 100, according to the third embodiment, for performing the space frequency block coding is shown. The coding device 100 of FIG. 11 differs from that shown in FIG. 9 in the bit stream divider 511, the converter array 512 and in the distributor 513. In the bit stream divider 511 shown in FIG. 11, the shift register array 511c includes n/2 shift registers, which is equal to a half the number of shifter registers provided in the shift register array 511c of FIG. 9. The same applies to the shift register array 511d. The converter array 512 of FIG. 11 includes n/2 converters 502-1 to 502-n/2 for receiving fragments from shift register array 511c, and n/2 converters 502-(n/2+1) to 502-n for receiving fragments from shift register array 511d. Each converter, such as converter 502-1 includes two transformers 501c-1 and 501d-1 for processing the same fragment, but in different frequencies. For example, transformer 501c-1 uses frequency f1, and transformer 501d-1 uses frequency f(n/2+1). The distributor 513 distributes the transformed signal according to the assigned frequency and antenna.

According to the embodiment shown in FIG. 11, the two transformers 501c-1 and 501d-1 in the converter 502-1 are processed in different frequencies, but in a modification, it is possible to use the same frequency. Also, the signals from the two transformers 501c-1 and 501d-1 in the converter 502-1 are applied to the same antenna, but in a modification, it is possible to apply the signals to different antennas.

In the above embodiments shown in FIGS. 9, 10 and 11, the number of antenna is not limited to two, but can be any other number. In such a case, the number of buffers should be increased accordingly.

In the above embodiments shown in FIGS. 10 and 11, the number of transformers is not limited to two, but can be any other number.

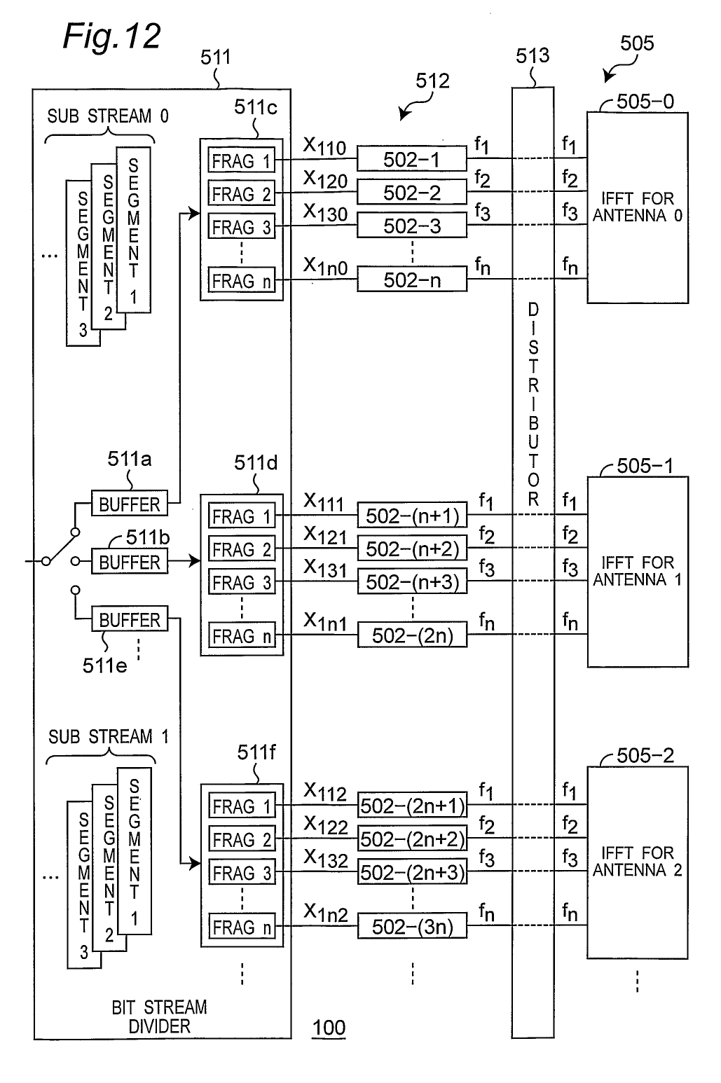

FIG. 12 shows a coding device 100 according to a fourth embodiment which is a general structure, and is designed as follows.

To transmit a bit stream S, first it must be divided into nₐ number of sub streams with each sub stream being denoted by Sᵢ where i=nₐ−1. Then each sub stream Sᵢ is further sub divide into nₛ number of segments. Each segment is fragmented into n_{f} number of fragments. A fragment represented by Xᵢⱼₖ as shown in FIG. 9, is input to a fragment converter array 512. A reference index Xᵢⱼₖ indicates such that the fragment j of segment i belongs to sub stream Sₖ. A fragment Xᵢⱼₖ is coded in frequency domain and carried by a frequency sub-carrier in order to facilitate transmission.

First, the fragments are prepared according to the steps shown in FIG. 7.

In the initialization stage of the system, three system parameters such as nₐ, n_{f} and n_{g} are determined. The parameter nₐ is the number of transmitting antennas to be used by the transmitting entity for transmitting the input bit stream that is processed by the system. The parameter n_{g} is the number of frequency sub-carriers available in the channel for transmitting the bit stream. The parameter n_{f} is the number of frequency sub-carriers selected to encode a segment of the stream. The parameter n_{f} is less than or equal to n_{g} and the parameter nₐ is less than or equal to the number of antennas associated with the transmitting entity. After those numbers are determined, fragment converters are formed. Each fragment applied to the fragment converter, such as 502-1, is processed in each transformer in the fragment converter. Each transformer is associated with a frequency that is used to code the output signal and an antenna for transmitting the output signal. The number of transformers in a fragment converter depends on the transformation employed on the signal. The total numbers of fragment converters in the system is bounded by nₐ*n_{f}.

To perform space frequency block coding or space time block coding, each fragment converter includes nₐ units of transformer. If all those transformers in fragment converter are assigned with different frequencies and associated with different antennas, spatial multiplexing coding can be performed on the input signal. In this case, n_{f} is equal to n_{g} divided by nₐ. If all those transformers in fragment converter are associated with different antennas but assigned with the same frequency and output of those transformers is time controlled, space time block coding can be performed on the input signal. To perform other coding, such as spatial multiplexing coding, each fragment converter includes one transformer only. Multiple bit streams can be transmitted simultaneously by having multiple system. Each system is assigned with a subset of transmitting antennas. Furthermore each bits stream can be employed with different type of transformation.

With the use of the system as shown in FIG. 12, spatial multiplexing and transmit spatial diversity can be facilitated. It is assumed that the system is employed in a m_{R}*nₐ antenna system, with m_{R}>=nₐ. m_{R} is the number of received antenna and nₐ is the number of transmit antenna.

To transmit a bit stream using spatial multiplexing technique, the system is configured with n_{f}=n_{g}, as shown in FIG. 9. The transformation unit 302 in each transformer is signaled to perform normal channel coding, for example convolution coding. The frequency assignment unit 303 of transformer is signaled to perform space frequency block coding at the base frequency that is associated with each fragment converter. The antenna assignment unit 304 of transformer is signaled to perform antenna assignment base on (c+d−1) mod nₐ, where c is the index of the sub stream that the current fragment belongs to and d is the index of the transformer among a plurality of transformers included in the converter. Finally, the bit steam is converted into the form as shown in FIG. 5. With all the setup being done, at each transmission time slot, new segments of all sub streams are fed into the system to produce transmission signal. This mode is used to increase the transmission rate.

To transmit a bits stream using space time block coding to achieve transmit spatial diversity, the system has to be configured with n_{f}=n_{g}, as shown in FIG. 10. The switches of all transformers are time controlled and a new segment of all sub streams are transmitted after n_{d} instances of transmission time slot, where n_{d} is the degree of transmit spatial diversity. For example, to apply Alamouti coding scheme on a 2*2 antenna system with the system shown in FIG. 10, which has 2 degree of transmit spatial diversity, the first step is to divide the bit stream into two sub streams. Then at each first transmission time slot, the switch of transformer 501a-1 in a fragment converter is closed and the switch of transformer 501b-1 in a fragment converter is opened. The transformation unit 302 of transformer is signaled to perform normal channel coding, for example convolution coding. The frequency assignment unit 303 of transformer is signaled to perform space frequency block coding at the base frequency that is associated with each instant of SYSTEM P. The antenna assignment unit 304 of transformer is signaled to perform antenna assignment base on (c+d−1) mod nₐ, where c is the index of the sub stream that the current fragment belongs to and d is the index of the transformer among a plurality of transformers included in the converter. At the next transmission time slot, the switch of transformer 501a-1 opens and the switch of transformer 501b-1 closes. The transformation unit of transformer that is used to process the first sub stream is signaled to perform X* on the input signal X. The transformation unit of transformer that is used to process the second sub stream is signaled to perform −Y* on the input signal Y. The frequency assignment and antenna assignment units are performing the same operation as it is in the first transmission time slot. A new segment of a sub streams is fed into the system for every two transmission time slots.

To transmit a bit stream using space frequency block coding to achieve transmit spatial diversity, the system is configured with n_{g}=n_{d}*n_{f}, as shown in FIG. 11, w here n_{d} is set to 2. The frequency assignment unit in transformer is signaled to perform space frequency block coding on the signal base on (b+d*f), where b is the base frequency that is associated with a fragment converter, d is the index of the transformer among a plurality of transformers included in the converter in the SYSTEM Q that the transformer is associated with and f is the frequency different between the two frequency set. The Transformation unit and Antenna Assignment unit are to perform the same operation as the example mentioned above. Transmit spatial diversity is used to increase the SNR of a transmitted signal.

Spatial Multiplexing can be combined with Transmit Spatial Diversity for multiple antenna system where the number of transmit antenna that is more than 3 transmit antennas and it is not a prime number. First, the number of antenna is to be factorized into the form of n_{d}*nₑ, where n_{d} and nₑ are not equal to 1. n_{d} is the degree of transmit spatial diversity and nₑ is the number of instances of the system as shown in FIG. 8 are to be created. Each instance of the system is associated with a distinct set of antennas. Each antenna set consists of n_{d} antennas.

Next, the polling and the communications between the transmitter and the receiver are described.

In multiple antennas system, multiple antennas can be active in the same frequency at the same time to facilitate spatial parallel transmission, with the limitation that the number of transmitting antennas cannot be greater than the number of receiving antennas. In order for receiver to receive and decode those spatial parallel transmissions, each individual antenna is required to be trained. In the training process, the transmitter transmits a known sequence and the receiver can, based on the received signal and the known sequence, acknowledge the channel that is to be used.

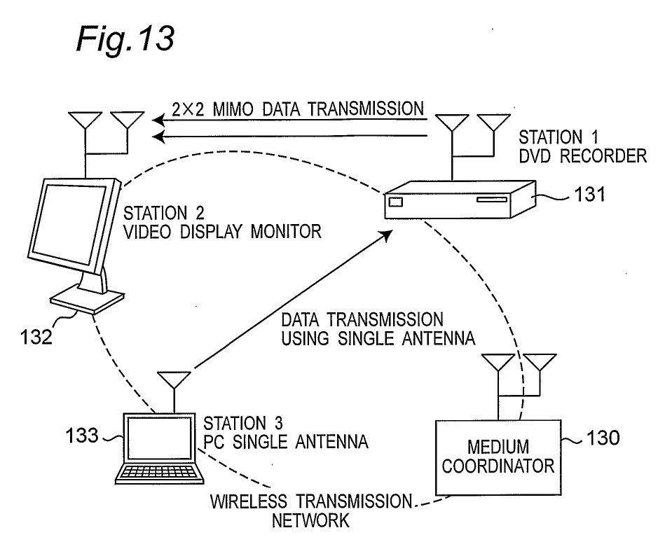

Referring to FIG. 13, an example of a system in which the present invention is applied is shown. In the system shown in FIG. 13, there are one medium coordinator 130 (which is usually an “Access point (AP) in IEEE802.11 Wireless LAN system) and 3 stations (1 & 2 & 3). Station 1 is a DVD Recorder 131, station 2 is a video display monitor 132, and station 3 is computer. It is assumed that station 1 is trying to send video data to station 2 using two antennas, and station 3 is trying to send data to station 1 using one antenna. In this case, because station 3 only has one antenna, MIMO transmission is not applicable. Thus, station 3 can send data by a single antenna.

First the polling is described for occupying a channel for a selected time T necessary to send data from DVD recorder 131 to video display monitor 132.

First, medium coordinator 130 sends a poll frame to DVD recorder 131.

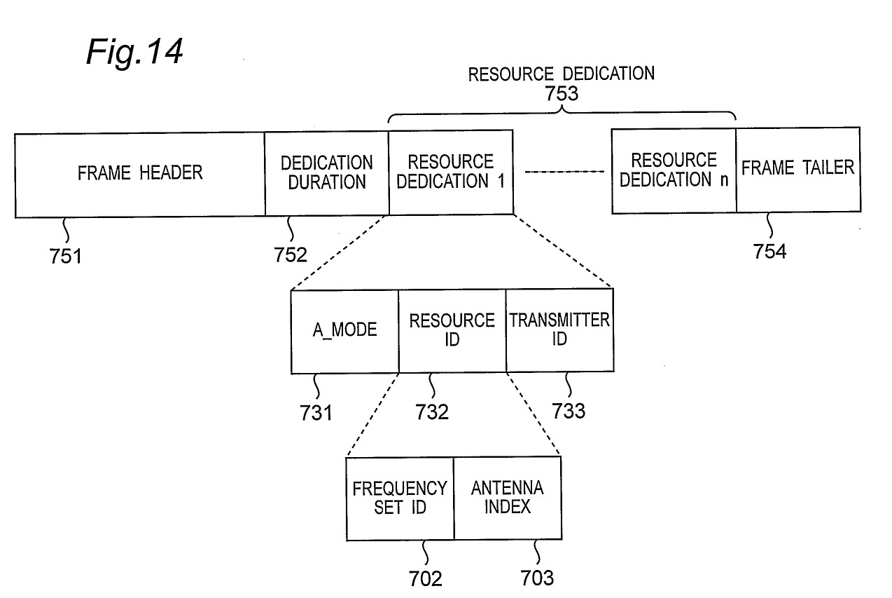

Referring to FIG. 14 the poll frame, which is also referred to as a medium resource dedication frame, is shown. The poll frame includes a frame header 715, a dedication duration 752, a plurality of resource dedications 753 and a frame tailer 754. Each resource dedication, such as resource dedication 1, includes an A_mode 731, a resource ID 732 and a transmitter ID 733. The resource ID 732 includes a frequency set ID 702 and an antenna index 703. The dedication duration 752 indicates the time length or time slot that can be occupied. The resource dedication is provided for each and every antenna in the wireless LAN system. In the case of FIG. 13, since there are seven antennas, resource dedications 1 to 7 are provided. The transmitter ID 733 indicates the device from which the data will be transmitted. In the case of FIG. 13, the transmitter ID 733 indicates one of medium coordinator 130, station 1, station 2 and station 3. The frequency set ID 702 indicates the frequency that is used for sending the poll frame. In the case of FIG. 13, only one frequency is used for sending the poll frame. The antenna index 703 indicates the antenna in each device.

In the example shown in FIG. 13, it is assumed that station 1 requests to transmit data to station 2 using two antennas from the transmitter (station 1) and two antennas at the receiver (station 2). When station 1 sends such a request to the medium coordinator 130, the medium coordinator 130 returns poll frame. In the returned poll frame, the dedication duration 752 specifies T (microseconds), and the resource dedications 1 and 2 are filled with information. In resource dedication 1, antenna index 703 specifies antenna 1, and transmitter ID 733 specifies station 1. In resource dedication 2, antenna index 703 specifies antenna 2, and transmitter ID 733 specifies station 1. In this manner, the medium coordinator 130 grants the [Dedicated duration]=T to both antenna 1 and 2 of station 1. Note that, frequency set ID 702 is not mentioned above, because only one frequency set is assumed. In general, the frequency set ID 702 should be set to a predetermined value which can be recognized by all station that only one frequency set is available.

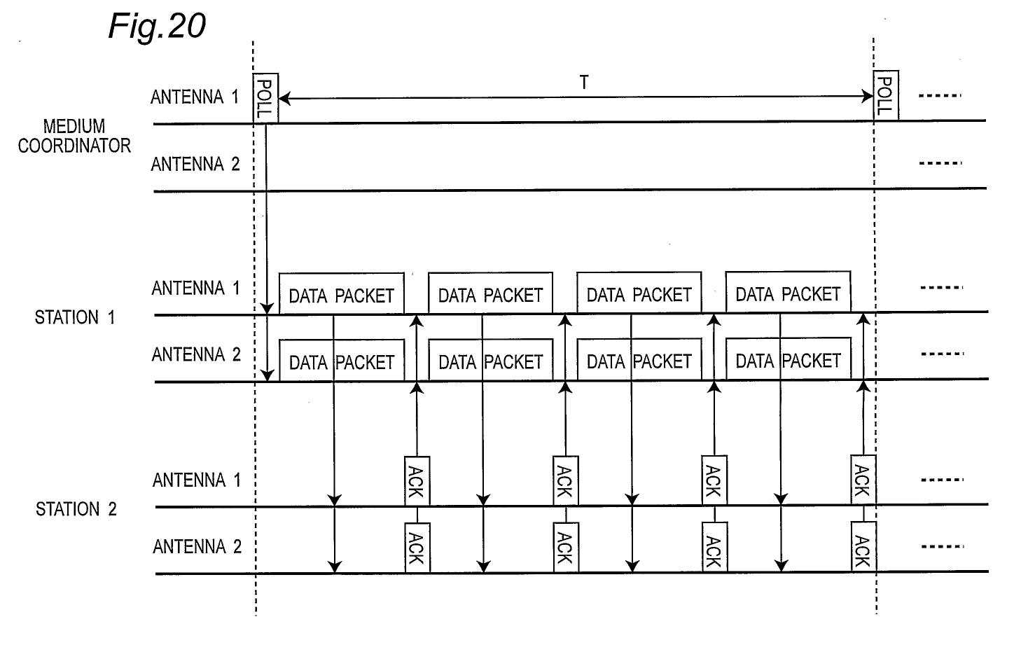

As shown in FIG. 20, the medium coordinator 130 sends poll frame to station 1. When station 1 receives the poll frame, station 1 realizes that it is allowed to occupy the channel up to T microseconds and the dedicated duration of T microseconds is granted to both of its antennas 1 and 2. Consequently, station 1 continuously sends data packets to station 2 within the dedication duration of T microseconds using both antennas 1 and 2. Note that, other ACK policies, such as 802.11e Block Acknowledgement can also be applied instead of the normal Acknowledgement.

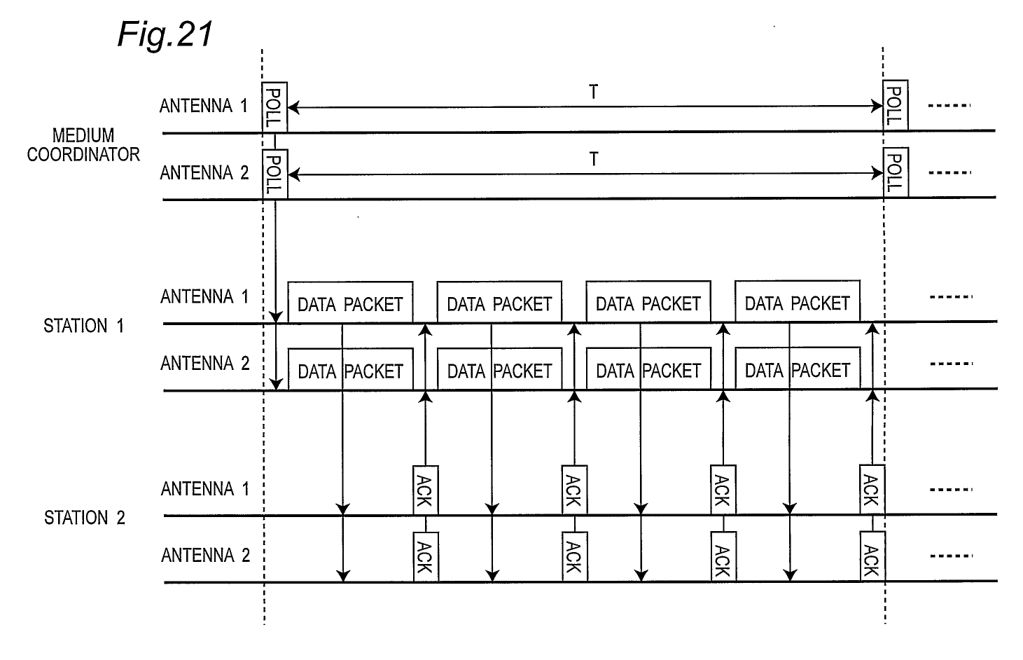

FIG. 21 shows a polling sequence for 2×2 data transmission using multiple antennas in case of multiple poll dedication. In the case of FIG. 20, the medium coordinator sends the poll frame from one antenna, but in the case of FIG. 21, the medium coordinator send the poll frame from antennas 1 and 2. This kind of polling mechanism is also applicable in multi antenna systems if signal orthogonality is provided for transmission of the poll frame.

Next, the data format for sending the data from station 1 to station 2 is described.

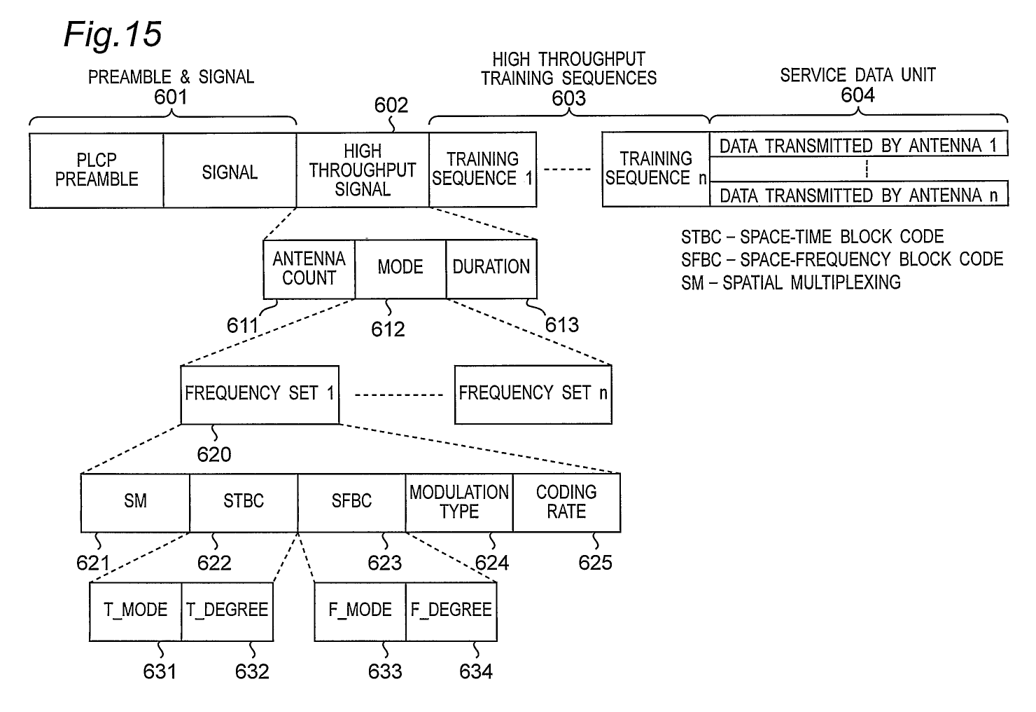

Referring to FIG. 15, the data format of the transmission data send from station 1 to station 2 is shown. The data format includes a legacy preamble and signal 601, a high throughput signal 602, a high throughput training sequences 603 and a service data unit 604. The high throughput signal 602 includes 3 sub fields, which are antenna count 611, mode 612 and duration 613. The antenna count 611 is used to indicate the number of transmit antennas that will participate in the PSDU transmission. The mode subfield 612 is used to indicate the transformation mode employed on the PSDU for the transmission. The duration subfield 613 is used to indicate the duration that is required to complete the transmission of the whole PSDU.

The Mode subfield 612 includes an entry for each available frequency set. Each entry of frequency set 620 is further subdivided into multiple subfields, such as SM 621, STBC 622, SFBC 623, modulation type 624 and coding rate 625. The SM field 621 is used to indicate the spatial multiplexing technique employed in the transmission. The STBC field 622 includes two subfields, which are T_mode 631 and T_degree 632. The T_mode subfield 631 is used to indicate that the Space-Time Block Code (or the type of Space-Time Block Code) is employed in the transmission. The T_degree subfield 632 is used to indicate the number of transmission time slots employed for coding a transmission signal. The SFBC field 623 includes two subfields, which are F_mode 633 and F_degree 634. The F_Mode subfield 633 is used to indicate that the Space-Frequency Block Code (or the type of Space-Frequency Block Code) is employed in the transmission. The F_degree subfield 634 is used to indicate the number of distinct frequency sub carriers employed for coding a transmission signal. The modulation type 624 is used to indicate the type of modulation scheme employed on PSDU for transmission. The coding rate 625 is used to indicate the coding employed on PSDU for transmission. The Duration field 613 is used to indicate the transmission time required to transmit a complete PSDU attached using the mode as indicated.

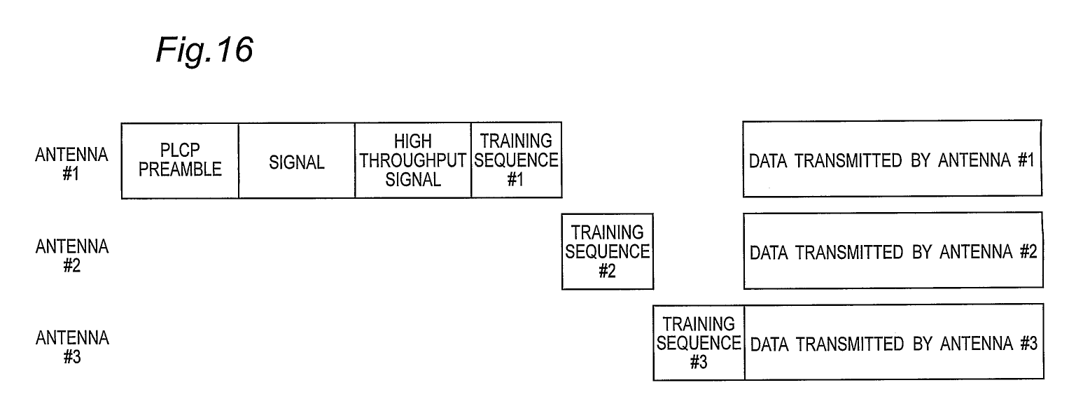

The training sequences 603 includes n number of training sequences, where n is the number as indicated in the antenna count field 611. The transmission data as described above can be send from station 1 to station 2 in various styles. Four different patterns are shown in FIGS. 16, 17, 18 and 19, in the case of using three antennas in one station.

Referring to FIG. 16 a first pattern is shown. In this case, antenna #1 sends the PLCP preamble, signal, high throughput signal, training sequence #1, and data transmitted by antenna #1. In this case the data transmitted by antenna #1 corresponds to the data produced, for example, from IFFT 505-0. It is noted that a blank period exists between the training sequence #1 and the data transmitted by antenna #1. In such a blank period, training sequence #2 and training sequence #3 are transmitted from other antennas. Antenna #2 sends the training sequence #2 after the training sequence #1 is completed, and also sends the data transmitted by antenna #2. Antenna #3 sends the training sequence #3 after the training sequence #2 is completed, and also sends the data transmitted by antenna #2.

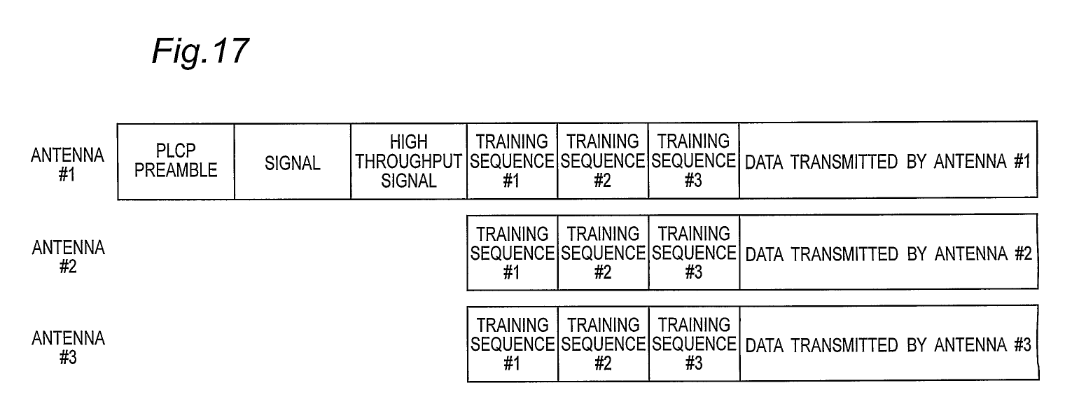

Referring to FIG. 17, a second pattern is shown. In this case, all three antennas #1, #2 and #3 sends the training sequences #1, #2 and #3. Other than this, the signal pattern from antennas #1, #2 and #3 is the same as that shown in FIG. 16.

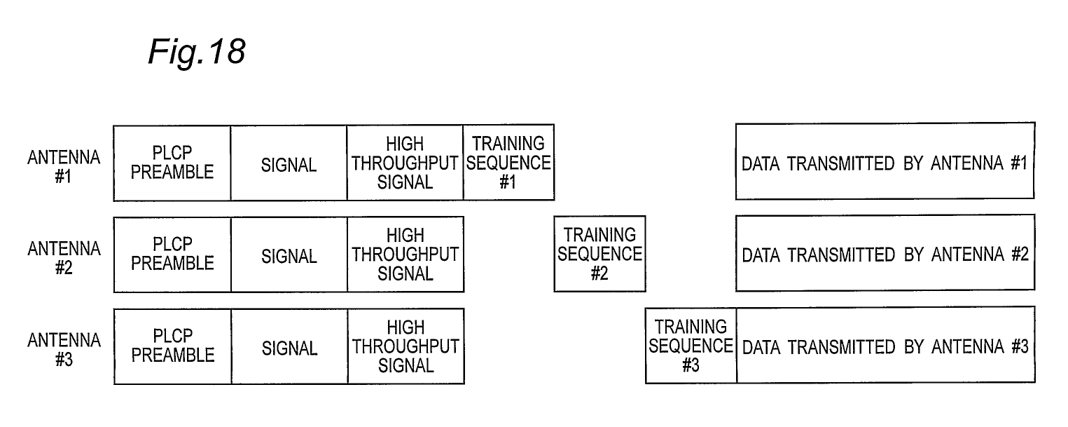

Referring to FIG. 18, a third pattern is shown. In this case, all three antennas #1, #2 and #3 sends the PLCP preamble, signal, and high throughput signal. Other than this, the signal pattern from antennas #1, #2 and #3 is the same as that shown in FIG. 16.

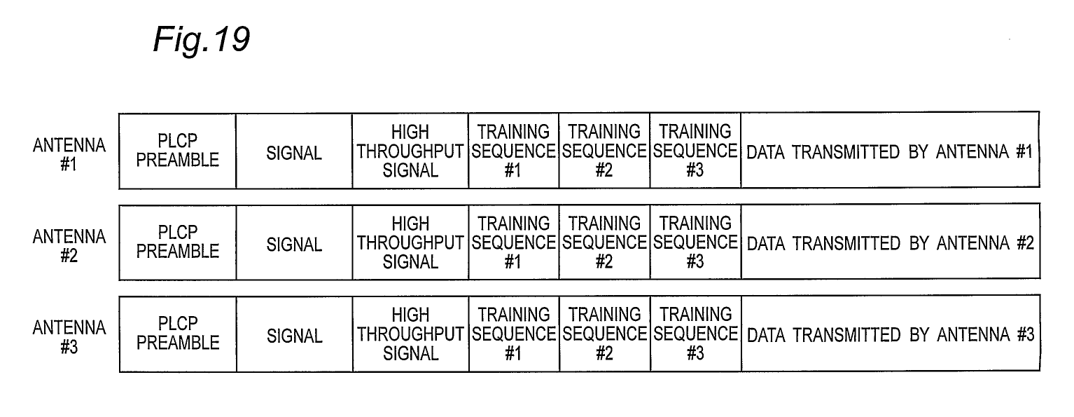

Referring to FIG. 19, a fourth pattern is shown. In this case, all three antennas #1, #2 and #3 sends the PLCP preamble, signal, high throughput signal, training sequences #1, #2 and #3, and data transmitted by respective antenna.

The polling and the communications between the transmitter and the receiver are further described from general viewpoint.

In a transmission of a PPDU, Legacy Preamble & Signal and High Throughput SIGNAL are transmitted by an antenna that is marked with index 1 only. After synchronization, if the SIGNAL in the Legacy Preamble & Signal indicated that the received PPDU is for high throughput, then the High Throughput SIGNAL is to be interpreted. After decoding the High Throughput SIGNAL, the end of training sequences and the end of the transmission are determined. If the transformation setting as indicated by the Mode field is not supported by the receiver, then the receiver will not interpret the remaining fields and remain ideal until the end of the transmission. After the transmission of Legacy Preamble & Signal and High Throughput SIGNAL, each transmitting antenna take turn to transmit a fix training sequence. Upon receiving a training sequence that is transmit by an antenna, a column of a matrix that representing the frequency response of the channel is constructed. The dimension of the matrix is n_{R}*n_{T}, where n_{R} is the number of receiving antennas that the receiver have and n_{T} is the number of antennas that are being used in the transmission as indicated in the Antenna Count field. Each column of the matrix is constructed in the sequential order. The matrix is then used to remove the frequency response of the channel from the received data signal in order to facilitate decoding of the transmitted signal.

In the multiple antennas system, each antenna is an instant of medium resource. Hereby it is denoted as Medium Resource Type I. In a transmission, the maximum instances of Medium Resource Type I that can be utilized are determined by the minimum number of antenna of all receiving entities. A transmission can consist of a single stream or multiple streams that are targeted to a receiving entity or multiple receiving entities. In OFDM system, each distinct set of frequency sub-carriers can be formed and visualized as an instant of medium resource. Hereby it is denoted as Medium Resource Type II. The maximum instances of Medium Resource Type II is determined by the number of distinct set of frequency sub-carriers that are being formed or configured during initialization and setup. The total number of medium resources that are available in a transmission that combining the two above mentioned systems are equal to n_{TypeI}*n_{TypeII}. n_{TypeI} is the maximum instances of Medium Resource Type I that are available in a transmission. n_{TypeII} is the maximum instances of Medium Resource Type II that are available in the system. Each instant of medium resource in the combined system can be identified by a Resource ID, which consists of two subfields: Frequency Set ID 702 and Antenna Index 703. Frequency Set ID 702 is a unique ID that uniquely identifies each instant of Medium Resource Type II. Antenna Index 703 is an index used to identify transmitting antenna of a transmission. So a Resource ID 732 can uniquely identify a transmitting antenna that is transmitting using all frequency sub-carriers belonging to a frequency set that is identified by the Frequency Set ID 702.

In multiple antennas & OFDM system, parallel transmissions of up to the number of instances of medium resources available are permitted. A transmission collision is being encountered when same instant of medium resource is being utilized by two transmission entity at the same instant of time. FIG. 14 shows a medium resource dedication frame format that is used to coordinate medium resource utilization in order to avoid collision. The medium resource dedication frame includes n resource dedication fields, where n is the number of medium resource dedication and is must not be greater than the number of medium resource instances available. Each resource dedication field includes two subfields, which are Resource ID 732 and transmitter ID 733. A special value, which is pre-determined, in any of the two subfields indicates that all medium resources of that type are being dedicated to the transmitting entity. If both subfields are being assigned with the special value, then the transmitting entity is being dedicated with all medium resources of all types. The Transmitter ID is the entity that is being dedicated to use the resources that are being identified by Resource ID. In a scenario where all station is having the same number of transmit antenna, the Medium Resource Dedication frame can be used to dedicate all medium resources to a station for a specific duration by using one Resource Dedication field and set Resource ID to contain the special value. In another scenario where station A and medium resource coordinator have two transmit antennas but station B & C has only one transmit antenna and two distinct frequency sub-carrier set are available for all station, the Medium Resource Dedication frame can be used to dedicate frequency sub-carrier set 1 with antenna index 1 & 2 to station A as well as dedicate frequency sub-carrier set 2 with antenna index 1 to station B and frequency sub-carrier set 2 with antenna index 2 to station C. If this dedication is done, those stations that are being dedicated with antenna index 1 are responsible to transmit Legacy Preamble & Signal and High Throughput Signal on the frequency sub-carrier set that are being dedicated.

Medium resource dedication required scheduling in order to meet the QoS requirement of all traffic streams that have registered their QoS expectation with medium resource coordinator. First is to determine the number of instances of medium resources that can be utilized by each individual station and denoted it by Rᵢ. Each resource is uniquely identified by Frequency Set ID+Antenna Index. At each resource allocation, each antenna is given an index. The total of index used to identify an antenna cannot be greater then the number of antenna at AP. Next is to compute the minimum of all delay tolerance at MAC & PHY for all data units that are originated from the station and denote it by DBminᵢ. Followed by determining the minimum number of dedication required for each station within DBminᵢ and denote it by Mminᵢ. This can be a pre-configured value that is determined by network administrator or abstract from the QoS requirement or retransmission requirement of individual station. Then compute the number of dedication required within DBminᵢ for each station in order to satisfy QoS requirement of respective station and denote it by Nᵢ, where Nᵢ is equal to max(Mminᵢ, Nminᵢ). Nminᵢ is the minimum number of dedication required by stationᵢ within DBminᵢ, which is computed by

$$⌈ \frac{{D}_{i}}{TXOP {max}_{i}} ⌉ ,$$

where TXOPmaxᵢ is the maximum duration that is allowed or pre-configured for each instant of dedication. Dᵢ is the medium occupancy time that is required within the DBminᵢ, which is computed by

$$\frac{{R}_{i} * DB {min}_{i}}{{M}_{i}} * {T}_{i} ,$$

where Rᵢ=Service Data unit generation rate for stations, Mᵢ=Total size of service data unit in a transmission unit that is initiated by stationᵢ and Tᵢ=The transmission time required to complete a transmission unit by stationᵢ that only utilize a single instant of resource. A transmission unit can consist of a single or multiple protocol data units and including necessary acknowledgement for those protocol data units. Each protocol data unit can consist of a single or partial or multiple service data units.

After Nᵢ, Mminᵢ & DBminᵢ are being computed, a dedication cycle, C that must be greater than or equal to

$$min ( \frac{DB {min}_{i}}{{N}_{i}} )$$

for all i and less than or equal to

$$min ( \frac{DB {min}_{i}}{M {min}_{i}} )$$

for all i, is to be determined. A means to determine a value for C is to choose the maximum value of

$$\frac{DB {min}_{j}}{{N}_{j}}$$

for a j that is still less than or equal to

$$min ( \frac{DB {min}_{i}}{M {min}_{i}} )$$

for all i. After a dedication cycle is being determined, the number of dedication that is required within a dedication cycle interval, NCᵢ and the duration of each dedication, TXOPᵢ, are to be computed. If all station can utilise the same number of resources (Rᵢ=Rⱼ for i< >j), then for each stationᵢ set RCᵢ to 1 and re-compute the medium occupancy time required within DBminᵢ with Tᵢ=The transmission time required to complete a transmission unit by stationᵢ that utilize Rᵢ instances of resource. Once the medium occupancy time required within DBminᵢ is updated, Nᵢ is also needed to be updated. If not all station can utilise the same number of resources, then set RCᵢ=Rᵢ. The computation for the number of dedication required within a dedication cycle interval is

$${NC}_{i} = C * \frac{{N}_{i}}{DB {min}_{i}}$$

and the duration of each dedication is

$${TXOP}_{i} = \frac{{D}_{i}}{{N}_{i}} .$$

The schedule being generated by the above method is the number of medium resource dedication and the duration of each dedication within each dedication cycle for each station. The schedule is to be combined with RCᵢ of each station in order to determine the number of Medium Resource Dedication frame to be generated.

First is to determine the total number of resources that are available for dedication, R. Then for each dedication interval, perform the medium dedication frame generation operation until the requirements of all transmitting entity are being fulfilled. The operation started by initialising R_{T}, which is the number of resources that are still available, to R and N_{Ti}, which is the number of medium resource dedication required for stationᵢ within a dedication cycle interval, to NCᵢ. For each transmitting entity, if N_{Ti} is greater than zero, then choose the minimum value among N_{Ti}, RCᵢ and R_{T} and assign it to T. T is used to indicate the numbers of units of medium resource dedication are to be dedicated to the transmitting entity. If the transmitting entity is having RCᵢ equal to 1, then a unit of medium resource dedication consists of Rᵢ instances of medium resource. If the transmitting entity is having RCᵢ equal to Rᵢ, then a unit of medium resource dedication is corresponding to an instant of medium resource. Then, subtract T from N_{TI} and construct Resource Dedication fields, which indicating the medium resources being allocated to the transmitting entity, that are to be incorporated into Medium Resource Dedication frame. After Resource Dedication fields are being generated, computed the number of medium resources that are still not being dedicated. If RCᵢ is not equal to Rᵢ, then R_{T} is equal to zero, else subtract T from R_{T}. If R_{T} is zero after the operation, then reset R_{T} back to R and release the medium resource dedication frame that is being constructed. The following is a pseudo code for the procedure for generating Medium Resource Dedication frame:

R_{T} = The number of resources that are available for dedication, R;
Do {

more = Flase;
For (i = 0; i < n; i++)

N_{Ti} = NCᵢ;

For (i = 0; i < n; i++) {

If (NCᵢ > 0) {

T = min(NCᵢ, RCᵢ, R_{T})
NCᵢ = NCᵢ − T;
If (NCᵢ > 0) then more = True;
Construct a Resource Dedication field that is to be
transmitted by Medium

Resource Dedication Frame;

If (RCᵢ <> Rᵢ)

R_{T} = 0;

Else

R_{T} = R_{T} − T;

If (R = 0) {

Release the Medium Resource Dedication frame
for transmission;
R_{T} = R;

}

}

}

} Until more = False;

### INDUSTRIAL APPLICABILITY

The present invention can be used for the method and apparatus to facilitate categorization of medium resources for multi-antenna wireless system.

1. A method for transmitting a bit stream by using at least first and second antennas comprising:
dividing said bit stream at least into a first sub stream and a second sub stream;
dividing each of said sub streams into at least first and second segments;
dividing each of said segments into a plurality of fragments;
processing said plurality of fragments in one segment from said first sub stream;
processing said plurality of fragments in one segment from said second sub stream;
applying the processed fragments in said first sub stream to said first antenna; and
applying the processed fragments in said second sub stream to said second antenna.

2. A method as claimed in claim 1, wherein said processing is a spatial multiplexing coding.

3. A method as claimed in claim 1, wherein said processing is a space time block coding.

4. A method as claimed in claim 1, wherein said processing is a space frequency block coding.

5. A method as claimed in claim 2, wherein said processing comprises transforming each fragment to a transmission signal to be carried in a first predetermined frequency.

6. A method as claimed in claim 3, wherein said processing comprises transforming a portion of each fragment to a transmission signal to be carried in a first predetermined frequency, and a remaining portion of the fragment to a transmission signal to be carried in said first predetermined frequency.

7. A method as claimed in claim 4, wherein said processing comprises transforming each fragment to a transmission signal to be carried in a first predetermined frequency, and the same fragment to a transmission signal to be carried in a second predetermined frequency.

8. A method as claimed in claim 1, wherein said processing comprises:
transforming each fragment to a transmission signal;
distributing the transmission signal; and
IFFT processing the transmission signal.

9. An apparatus for transmitting a bit stream by using at least first and second antennas comprising:
a bit stream divider for dividing said bit stream at least into a first sub stream and a second sub stream;
a sub stream divider for dividing each of said sub streams into at least first and second segments;
a segment divider for dividing each of said segments into a plurality of fragments; and
a processor for processing said plurality of fragments in one segment from said first sub stream, and for processing said plurality of fragments in one segment from said second sub stream;
wherein the processed fragments in said first sub stream are applied to said first antenna, and the processed fragments in said second sub stream are applied to said second antenna.

10. An apparatus as claimed in claim 9, wherein said processor performs a spatial multiplexing coding.

11. An apparatus as claimed in claim 9, wherein said processor performs a space time block coding.

12. An apparatus as claimed in claim 9, wherein said processor performs a space frequency block coding.

13. An apparatus as claimed in claim 10, wherein said processor comprises a transformer for transforming each fragment to a transmission signal to be carried in a first predetermined frequency.

14. An apparatus as claimed in claim 11, wherein said processor comprises a first transformer for transforming a portion of each fragment to a transmission signal to be carried in a first predetermined frequency, and a second transformer for transforming a remaining portion of each fragment to a transmission signal to be carried in said first predetermined frequency.

15. An apparatus as claimed in claim 12, wherein said processor comprises a first transformer for transforming each fragment to a transmission signal to be carried in a first predetermined frequency, and a second transformer for transforming the same fragment to a transmission signal to be carried in a second predetermined frequency.

16. An apparatus as claimed in claim 9, wherein said processor comprises:
a transformer for transforming the fragment to transmission signal;
a distributer for distributing the transmission signal; and
an IFFT processor for IFFT processing the transmission signal.

17. In a system for transmitting a bit stream from a first station to a second station using at least first and second transmitting antennas provided in the first station and at least first and second receiving antennas provided in the second station, with a coordinator providing at least one control signal having a poll frame for controlling the time duration for the transmission, said poll frame comprising:
a transmitter ID for specifying said first station;
an antenna index for specifying each of said first and second transmitting antennas in said first station; and
a frequency set ID for specifying a carrier frequency of a transmission signal from each of said first and second transmitting antennas in said first station.

18. In a system for transmitting a bit stream from a first station to a second station using at least first and second transmitting antennas provided in the first station and at least first and second receiving antennas provided in the second stations said bit stream comprising:
a frequency set indicating at least one of a space time block coding mode or a space frequency block coding mode, and
a training sequence for training the transmission using at least two transmitting antennas and at least two receiving antennas.
